(19) United States
(12) Patent Application Publication
(10) Pub. No.: US 2013/0088460 A1
(43) Pub. Date: Apr. 11, 2013

(54) OPTICAL TOUCH SCREEN APPARATUS AND METHOD OF MANUFACTURING THE OPTICAL TOUCH SCREEN APPARATUS

(71) Applicants: Seung-eon Ahn, Hwaseong-si (KR); I-hun Song, Hwaseong-si (KR); Sang-hun Jeon, Seoul (KR); Chang-jung Kim, Yongin-si (KR); Young Kim, Yongin-si (KR); Yong-woo Jeon, Seoul (KR)

(72) Inventors: Seung-eon Ahn, Hwaseong-si (KR); I-hun Song, Hwaseong-si (KR); Sang-hun Jeon, Seoul (KR); Chang-jung Kim, Yongin-si (KR); Young Kim, Yongin-si (KR); Yong-woo Jeon, Seoul (KR)

(73) Assignee: SAMSUNG ELECTRONICS CO., LTD., Suwon-si (KR)

(21) Appl. No.: 13/563,911

(22) Filed: Aug. 1, 2012

(30) Foreign Application Priority Data
Oct. 5, 2011 (KR) 10-2011-0101411

(51) Int. Cl. G06F 3/042

(52) U.S. Cl. 345/175

(57) ABSTRACT

An optical touch screen apparatus that includes a display pixel including a display cell and a driving transistor, the display cell configured to display an image and the driving transistor configured to turn on or off the display cell, the driving transistor having a double gate structure; and a light-sensing pixel including a light-sensing transistor and a switch transistor, the light-sensing transistor configured to sense incident light and the switch transistor configured to output data from the light-sensing transistor, the switch transistor having the double gate structure, wherein the double gate structure is a structure in which a bottom gate and a top gate are arranged such that a channel layer is disposed therebetween. The top gate may be formed together when forming a transparent electrode in the pixel, and thus even when the top gate is further included, the number of manufacturing processes is not increased.

### CROSS-REFERENCE TO RELATED APPLICATIONS

This application claims the benefit of Korean Patent Application No. 10-2011-0101411, filed on Oct. 5, 2011, in the Korean Intellectual Property Office, the disclosure of which is incorporated herein in its entirety by reference.

### BACKGROUND

1. Field

The present disclosure relates to optical touch screen apparatuses and efficient methods of manufacturing the same.

2. Description of the Related Art

Touch screen devices are devices which directly receive input data through a screen by recognizing a position of, for example, a finger, a stylus, or the like, touching the screen and performing a particular process with software. To this end, a touch screen device is equipped with a touch panel to perform such a function. Touch panels included in the touch screen devices may include resistive overlay type touch panels, capacitive overlay type touch panels, surface acoustic wave (SAW) type touch panels, infrared beam type touch panels, piezoelectric type touch panels, or the like. The touch screen devices are widely used in a variety of fields as an input device for replacing a keyboard or a mouse.

A touch screen device that has been widely used employs a method of directly touching a screen of a display device with a finger or a stylus. However, as the size of a display device increases, the distance between the display device and a user increases. In this case, use of the direct touch method may be difficult to adopt. Accordingly, optical touch screen devices that may perform the same function as existing touch screens by sensing light instead of sensing contact of a finger or a stylus have been proposed. An optical touch screen device is expected to facilitate communication not only between a user and a terminal but also between users.

In order to realize an optical touch panel, a relatively small-sized light-sensing device for sensing light is required. An amorphous silicon thin film transistor (a-Si TFT) is one of such light-sensing devices that are generally used. However, an a-Si TFT does not exhibit a sufficient current change according to light. Accordingly, when light is incident, electric charges generated by a photodiode are accumulated in a capacitor for a predetermined period of time and then a signal related to light intensity is generated from the quantity of electric charges accumulated in the capacitor. When a capacitor is used as described above, a sensing time may be delayed by as long as the time for accumulating electric charges in the capacitor. In addition, a larger-sized optical touch screen device may lead to a higher parasitic capacitance.

### SUMMARY

Provided are optical touch screen apparatuses including a light-sensing transistor for sensing light and a switch transistor for outputting a light-sensing signal from the light-sensing transistor.

Provided are methods of manufacturing of the optical touch screen apparatuses, by which a light-sensing transistor and a switch transistor may be manufactured together without an additional manufacturing process and a decrease in performance of the switch transistor.

Additional aspects will be set forth in part in the description which follows and, in part, will be apparent from the description, or may be learned by practice of the presented embodiments.

According to an aspect of the present invention, an optical touch screen apparatus includes: a display pixel including a display cell and a driving transistor. The display cell configured to display an image and the driving transistor configured to turn on or off the display cell, the driving transistor having a double gate structure; and a light-sensing pixel including a light-sensing transistor and a switch transistor. The light sensing transistor configured to sense incident light and a switch transistor configured to output data from the light-sensing transistor, the switch transistor having the double gate structure, wherein the double gate structure is a structure in which a bottom gate and a top gate are arranged such that a channel layer is disposed therebetween.

The light-sensing transistor may have a single gate structure that includes a single gate.

The light-sensing transistor, the driving transistor, and the switch transistor may be oxide semiconductor transistors in which a channel layer is formed of an oxide semiconductor.

The driving transistor and the switch transistor may each include: a substrate; the bottom gate partially disposed on the substrate; a gate insulation film disposed on the substrate and the bottom gate, the gate insulation film covering the bottom gate; a source and a drain respectively disposed on two sides of the channel layer to partially cover the two sides of the channel layer, the channel layer disposed on the gate insulation film facing the bottom gate; a passivation layer disposed to cover the channel layer, the source, and the drain; and the top gate disposed on the passivation layer to face the channel layer.

The driving transistor and the switch transistor may share a single bottom gate and a single top gate.

The bottom gate and the top gate may be electrically connected to each other such that the bottom gate and the top gate receive an electrical signal simultaneously.

The light-sensing transistor may include: a substrate; a gate partially disposed on the substrate; a gate insulation film disposed on the substrate and the gate to cover the gate; a channel layer disposed on the gate insulation film to face the gate; a source and a drain respectively disposed on two sides of the channel layer to cover the two sides of the channel layer; and a passivation layer disposed to cover the channel layer, the source, and the drain.

The channel layer of the driving transistor and the switch transistor may have the same structure and include the same oxide semiconductor material as those of the channel layer of the light-sensing transistor.

The optical touch screen apparatus may further include: a gate line configured to supply a gate voltage to the driving transistor and the switch transistor; an image data line configured to supply an image signal to the display cell; a light-sensing line configured to output a light-sensing signal from the light-sensing transistor; a driving voltage line connected to a drain of the light-sensing transistor; and a reset line configured to supply a reset signal to the light-sensing transistor.

A source of the driving transistor may be connected to the display cell, and the light-sensing transistor and the switch transistor are serially connected to each other.

The optical touch screen apparatus may further include: a first transparent substrate and a second transparent, the second transparent substrate facing the first transparent substrate; a first transparent electrode disposed on the first substrate; and a second transparent electrode disposed below the second substrate.

The driving transistor and the switch transistor may each include: a gate insulation film disposed on the first transparent substrate and the bottom gate to cover the bottom gate, the bottom gate being partially disposed on the first transparent substrate; a source and a drain respectively disposed on two sides of the channel layer to partially cover the two sides of the channel layer, the channel layer disposed on the gate insulation film facing the bottom gate; a passivation layer disposed to cover the channel layer, the source, and the drain; and the top gate disposed on the passivation layer to face the channel layer.

The first transparent electrode may be disposed on the passivation layer to face the display cell, and the top gate and the first transparent electrode may be formed of the same material at the same time.

The optical touch screen apparatus may further include a color filter and a black matrix disposed on a lower surface of the second transparent substrate.

The color filter may be disposed to face the display cell, and the black matrix may be disposed to face the driving transistor and the switch transistor.

According to another aspect of the present invention, a method of manufacturing an optical touch screen apparatus, the method includes: forming a display cell between the first transparent substrate and the second transparent substrate. The first transparent substrate having a driving transistor, a light-sensing transistor, a switch transistor, and a first transparent electrode formed thereon, the driving transistor and the switch transistor each having a double gate structure. The double gate structure being a structure in which a bottom gate and a top gate are disposed with a channel layer disposed therebetween.

The forming of a first transparent substrate may include: forming a first gate of the driving transistor and the switch transistor and a second gate of the light-sensing transistor on the first transparent substrate; forming a gate insulation film on the first transparent substrate and the first and second gates to cover the first and second gates; forming a first channel layer and a second channel layer on the gate insulation film to respectively face the first gate and the second gate; forming a first source and a first drain on two sides of the first channel layer to partially cover the two sides of the first channel layer; forming a second source and a second drain on two sides of the second channel layer to partially cover the two sides of the second channel layer; forming a passivation layer to cover the first and second channel layers, the first and second sources, and the first and second drains; and forming a third gate on the passivation layer to face the first channel layer.

The bottom gate may be the first gate, and the top gate may be the third gate.

The method may further include electrically connecting the first gate and the third gate to each other.

The first channel layer and the second channel layer may have the same structure and be made of the same oxide semiconductor material.

The method may further include forming the first transparent electrode on the passivation layer to face the display cell, wherein the first transparent electrode and the third gate are formed of the same material at the same time.

The providing a second transparent substrate may include: forming the color filter on a lower surface of the second transparent substrate to face the display cell; and forming the black matrix on the lower surface of the second transparent substrate to face the driving transistor and the switch transistor.

### BRIEF DESCRIPTION OF THE DRAWINGS

These and/or other aspects will become apparent and more readily appreciated from the following description of the embodiments, taken in conjunction with the accompanying drawings in which:

FIG. 1 is a cross-sectional view schematically illustrating a structure of a light-sensing transistor of an optical touch screen apparatus, according to an embodiment of the present invention;

FIG. 2 is a graph showing operating characteristics of the light-sensing transistor of FIG. 1;

FIG. 3 is a circuit diagram illustrating a pixel of an optical touch screen apparatus according to an embodiment of the present invention;

FIG. 4 is a cross-sectional view schematically illustrating a structure of a driving transistor or a switch transistor according to an embodiment of the present invention;

FIG. 5 is a graph showing the performance of a driving transistor and a switch transistor having a top gate;

FIG. 6 is a graph showing a variation in a threshold voltage of a driving transistor and a switch transistor without a top gate according to time;

FIG. 7 is a graph showing a variation in a threshold voltage of a driving transistor and a switch transistor including a top gate according to time;

FIGS. 8A through 8H are cross-sectional views illustrating a method of manufacturing a driving transistor and a switch transistor and a light-sensing transistor at the same time, according to an embodiment of the present invention; and

FIG. 9 is a cross-sectional view illustrating a structure of a pixel of an optical touch screen apparatus according to an embodiment of the present invention.

### DETAILED DESCRIPTION

Example embodiments will now be described more fully with reference to the accompanying drawings, in which some example embodiments are shown. In the drawings, the thicknesses of layers and regions are exaggerated for clarity. Like reference numerals in the drawings denote like elements.

Detailed illustrative embodiments are disclosed herein. However, specific structural and functional details disclosed herein are merely representative for purposes of describing example embodiments. Example embodiments may be embodied in many alternate forms and should not be construed as limited to only those set forth herein.

It should be understood, however, that there is no intent to limit this disclosure to the particular example embodiments disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of this disclosure. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Reference will now be made in detail to embodiments, examples of which are illustrated in the accompanying drawings, wherein like reference numerals refer to like elements throughout. Also, the sizes of elements may be exaggerated for clarity and convenience of description. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

An oxide semiconductor transistor is a transistor in which an oxide semiconductor is used as a material for a channel. The oxide semiconductor transistor may have a characteristic of being sensitive to light according to an oxide semiconductor material that is used as a channel layer. When an oxide semiconductor material having such a characteristic is used as a channel layer, an oxide semiconductor transistor has a characteristic that a threshold voltage and a drain current change according to a wavelength or quantity of incident light. Accordingly, the oxide semiconductor transistor may be used as a light-sensing transistor.

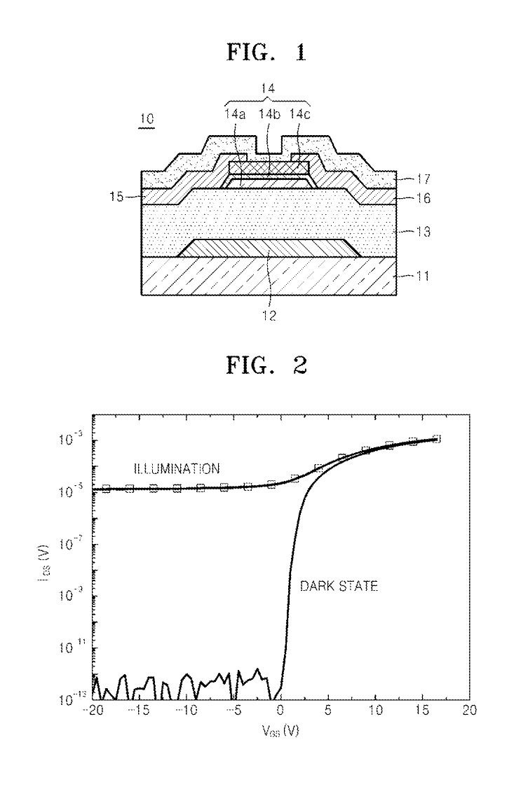

FIG. 1 is a cross-sectional view schematically illustrating a light-sensing transistor 10 of an optical touch screen apparatus, according to an embodiment of the present invention. Referring to FIG. 1, the light-sensing transistor 10 may include a substrate 11, a gate 12 partially disposed on the substrate 11, a gate insulation film 13 disposed on the substrate 11 and the gate 12 to cover the gate 12, a channel layer 14 disposed on the gate insulation film 13 to face the gate 12, a source 15 and a drain 16 disposed on the gate insulation film 13 to cover two sides of the channel layer 14, and a passivation layer 17 disposed to cover the channel layer 14, the source 15, and the drain 16 overall. The substrate 11 may use a general substrate material, for example, glass, silicon, or the like. The gate insulation film 13 and the passivation layer 17 may use a material such as SiO2 or SiNx. The gate 12, the source 15, and the drain 16 may be formed of a conductive metal or a conductive metal oxide.

The light-sensing transistor 10 is the above-described oxide semiconductor transistor. Thus, the channel layer 14 may be formed of an oxide semiconductor material. According to the oxide semiconductor material used as the channel layer 14, the light-sensing transistor 10 may have light-sensing characteristics. For example, an oxide semiconductor material such as ZnO, InO, SnO, InZnO, ZnSnO, and InSnO may be used, or a mixed material of these oxide semiconductor materials with at least one of the group consisting of hafnium (Hf), zirconium (Zr), titanium (Ti), tantalum (Ta), gallium (Ga), niobium (Nb), vanadium (V), aluminium (Al), and tin (Sn) may be used as the oxide semiconductor material. When these materials are used to form the channel layer 14, the light-sensing transistor 10 of FIG. 1 may have a varying threshold voltage and a varying drain current that depend on the wavelength and/or quantity of incident light, thus may be used as a light-sensing device. A wavelength range of light sensed by the light-sensing transistor 10 may vary depending on the kind of oxide semiconductor used in the channel layer 14.

The channel layer 14 may be formed of a layer or may have a multi-layer structure to improve the performance and reliability of the light-sensing transistor 10. For example, the channel layer 14 may have a three-layer structure including a lower channel layer 14a, a central channel layer 14b, and an upper channel layer 14c. The lower channel layer 14a may be formed of InZnO, which is relatively sensitive to light, and the central channel layer 14b may be formed of GaInZnO to protect the lower channel layer 14a and to stably maintain a threshold voltage of the light-sensing transistor 10. Also, the upper channel layer 14c may be a transparent etching stop layer.

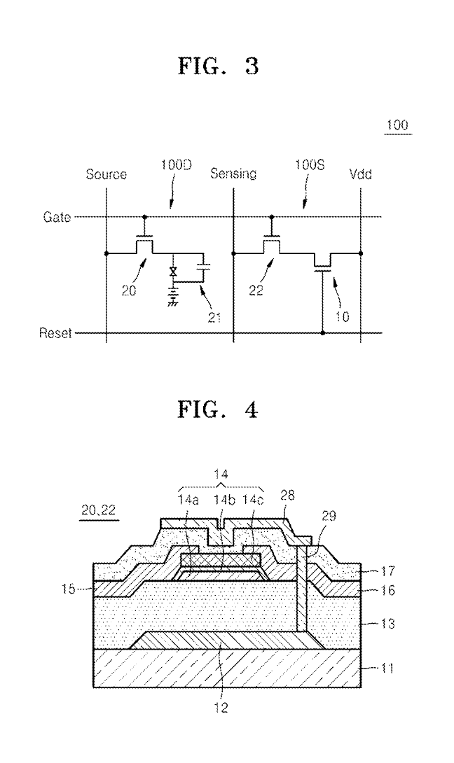

FIG. 2 is a graph showing operating characteristics of the light-sensing transistor 10 of FIG. 1. In detail, a graph of gate voltage (Vgs)-drain current (Ids) characteristics of the light-sensing transistor 10 is shown. Referring to FIG. 2, when light is incident on the light-sensing transistor 10, a drain current of the light-sensing transistor 10 is increased when the light-sensing transistor 10 is turned off. For example, when a gate voltage greater than a threshold voltage is applied to the light-sensing transistor 10, as shown in a right portion of the graph of FIG. 2, a drain current at the time when light is incident (illumination state) and a drain current at the time when light is not incident (dark state) are almost the same. However, when a gate voltage lower than the threshold voltage is applied to the light-sensing transistor 10, as shown in a left portion of the graph of FIG. 2, a drain current at the time when light is incident is far greater than a drain current at the time when light is not incident.

Accordingly, whether light is incident or not may be determined by measuring a drain current while a gate voltage lower than a threshold voltage is applied to the light-sensing transistor 10. In particular, a current ratio (I_{ON}/I_{OFF}) of a drain current I_{ON} at the time when light is incident and a drain current I_{OFF} at the time when light is not incident in the light-sensing transistor 10 formed of an oxide semiconductor is considerably high. When the light-sensing transistor 10 having these characteristics is used as a light-sensing device, various effects may be obtained. For example, since the light-sensing transistor 10 has a high current ratio, if the above-described light-sensing transistor 10 is used as a light-sensing device, a very simple light-sensing circuit with no capacitor may be implemented. Also, as the light-sensing circuit is simplified, an In-cell type optical touch screen apparatus in which a display pixel and a light-sensing pixel are integrated may be easily implemented.

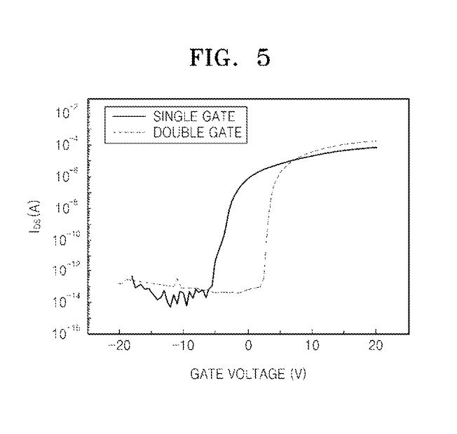

FIG. 3 is a circuit diagram illustrating a pixel of an In-cell optical touch screen apparatus 100 according to an embodiment of the present invention. Referring to FIG. 3, the pixel of the In-cell type optical touch screen apparatus 100 may include a display pixel 100D and a light-sensing pixel 100S. The display pixel 100D may include a display cell 21 (for example, a liquid crystal cell in a liquid crystal display (LCD)) and a driving transistor 20 for turning on/off the display cell 21. Also, the light-sensing pixel 100S may include a light-sensing transistor 10 for sensing incident light and a switch transistor 22 for outputting a light-sensing signal from the light-sensing transistor 10. Gates of the driving transistor 20 and the switch transistor 22 are connected to a single gate line Gate. Also, a drain of the driving transistor 20 may be connected to an image data line Source, and a source of the driving transistor 20 may be connected to the display cell 21. The light-sensing transistor 10 may be an oxide semiconductor transistor having the structure illustrated in FIG. 1. The light-sensing transistor 10 may be serially connected to the switch transistor 22. That is, a drain of the switch transistor 22 may be connected to a source of the light-sensing transistor 10. A source of the switch transistor 22 may be connected to a light-sensing line Sensing, and a drain of the light-sensing transistor 10 may be connected to a driving voltage line Vdd, and a gate of the light-sensing transistor 10 may be connected to a reset line Reset.

In the above-described circuit, when a gate voltage is applied to the driving transistor 20 and the switch transistor 22 via the gate line Gate, the driving transistor 22 and the switch transistor 22 are turned on. Then, an image signal of the image data line Source is applied to the display cell 21 in the display pixel 100D such that the display cell 21 displays an image. Meanwhile, a current flows from the source of the light-sensing transistor 10 to the light-sensing line Sensing in the light-sensing pixel 100S. Here, a current amount flowing from the light-sensing transistor 10 to the light-sensing line Sensing varies according to the intensity of light that is incident on the light-sensing transistor 10. Accordingly, the intensity of light incident on the light-sensing transistor 10 may be calculated by measuring the current amount flowing through the light-sensing line Sensing. In order to output a light-sensing signal, while the switch transistor 22 is being turned on, a voltage lower than a threshold voltage is applied to the gate of the light-sensing transistor 10. Meanwhile, while a gate voltage is not applied to the switch transistor 22, the switch transistor 22 is turned off, and thus no current flows through the light-sensing line Sensing. Accordingly, a light-sensing signal may be output by controlling the switch transistor 22, and whether light is incident on the light-sensing transistor 10 or not and the intensity of light may be detected from the intensity of the light-sensing signal. After light is measured once from the light-sensing transistor 10, for a next measurement, a positive gate voltage may be applied to the gate of the light-sensing transistor 10 via the reset line Reset.

In the optical touch screen apparatus 100 having the above-described structure, the light-sensing transistor 10 is required to be sensitive to light, and a high operational speed and stability are required from the driving transistor 20 and the switch transistor 22. To this end, the structures of the driving transistor 20 and the switch transistor 22 may be formed differently from that of the light-sensing transistor 10. For example, different structures and materials may be selected for channel layers of the driving transistor 20 and the switch transistor 22 from the structure and material of the channel layer 14 of the light-sensing transistor 10. However, in this case, the manufacturing process of the driving transistor 20 and the switch transistor 22 is different from the manufacturing process of the light-sensing transistor 10, and thus the number of manufacturing process is increased, thereby increasing usage of expensive masks. Accordingly, it may be effective to increase the operational speed and stability of the driving transistor 20 and the switch transistor 22 while forming the driving transistor 20 and the switch transistor 22 in the same method of forming the light-sensing transistor 10.

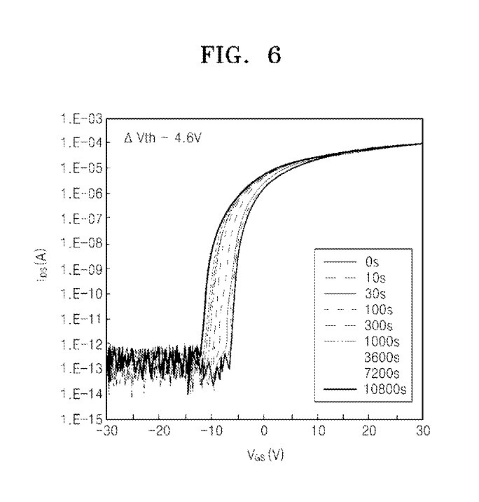

FIG. 4 is a cross-sectional view schematically illustrating structures of the driving transistor 20 or the switch transistor 22 according to an embodiment of the present invention to obtain the above-described effects. Referring to FIG. 4, the driving transistor 20 and the switch transistor 22 include the same structure as that of the light-sensing transistor 10, and further include a top gate 28 disposed on the passivation layer 17 to face the channel layer 14. The top gate 28 may be formed of a conductive material such as ITO or IZO. The top gate 28 may be electrically connected to the gate 12 therebelow via a conductive plug 29. Accordingly, a gate voltage may be synchronously applied to the gate 12 and the top gate 28. In this respect, the driving transistor 20 and the switch transistor 22 have a double gate structure in which the gate 12 and the top gate 28 are arranged above and below with the channel layer 14 therebetween.

Here, the conductive plug 29 does not need to be disposed on every driving transistor 20 and every switch transistor 22. Since the driving transistor 20 and the switch transistor 22 may be connected to the single gate line Gate as illustrated in the circuit diagram of FIG. 3, the driving transistor 20 and the switch transistor 22 may be configured to share the single gate 12. For example, referring to FIG. 4, the gate 12 and the top gate 28 may extend in a direction perpendicular to the drawing surface, and the driving transistor 20 and the switch transistor 22 may be sequentially arranged while sharing the gate 12 and the top gate 28. In particular, if the display pixel 100D has three sub-pixels, i.e., red, green, and blue (RGB) sub-pixels, three driving transistors 20 and one switch transistor 22 may be arranged in a direction perpendicular to a drawing surface while sharing one gate 12 and the single top gate 28. Accordingly, as long as the conductive plug 29 is connected between the gate 12 and the top gate 28 at any one point in the pixel, the gate 12 and the top gate 28 of the driving transistor 20 and the switch transistor 22 may be regarded as being electrically connected. In this respect, the conductive plug 29 illustrated in FIG. 4 simply shows that the gate 12 and the top gate 28 are electrically connected, and the conductive plug 29 does not have to pass through the passivation layer 17, the drain 16, and the gate insulation film 13.

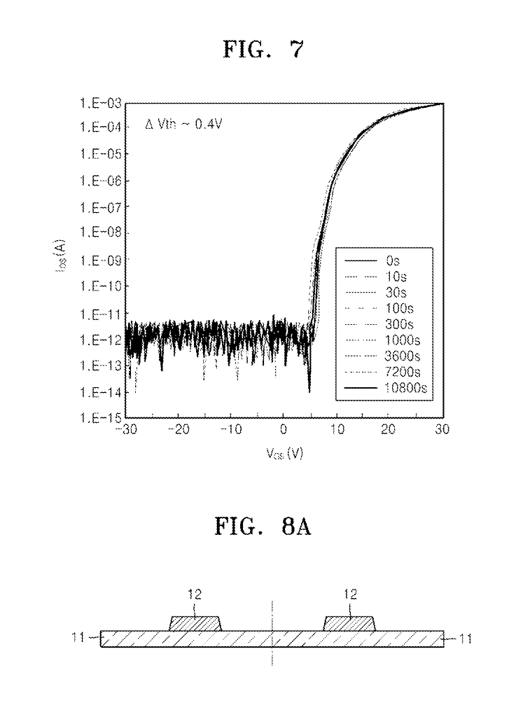

FIG. 5 is a graph showing the performance of the driving transistor 20 and the switch transistor 22 having the top gate 28. Referring to FIG. 5, compared to when a single gate 12 is included, a stable threshold voltage is maintained and a drain current may increase in an ON state in a double gate structure in which the top gate 28 is further included. Accordingly, the sizes of the driving transistor 20 and the switch transistor 22 may be reduced by the increased drain current in the ON state, and thus the size of the display cell 21 which substantially displays an image may be increased by the amount of increased current. Accordingly, according to the current embodiment of the present invention, the aperture ratio and resolution of the optical touch screen apparatus 100 may be increased.

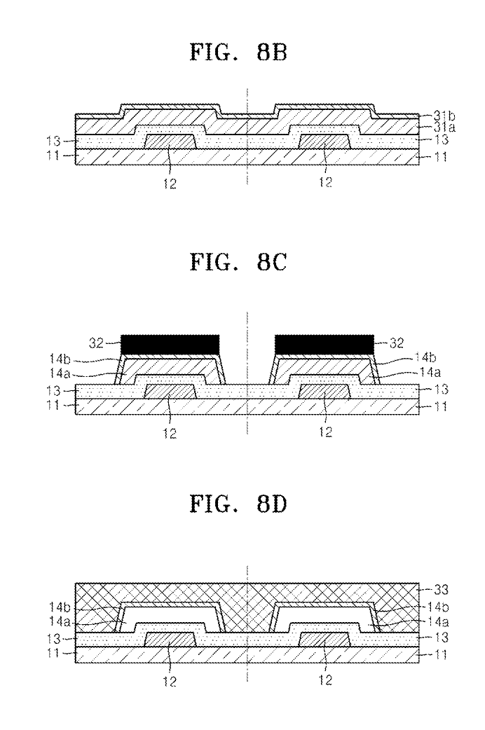

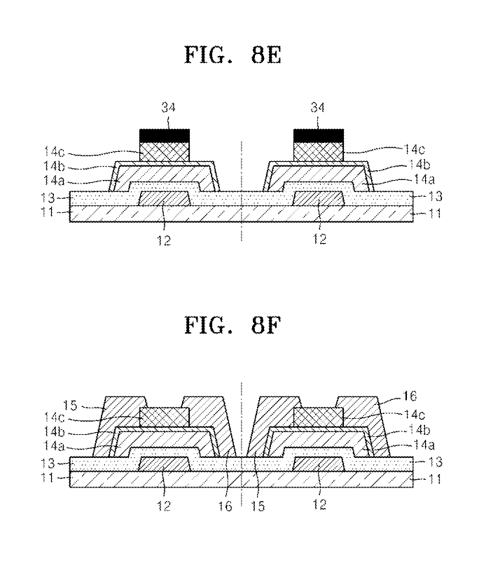

Also, in a single gate structure including only one gate 12, a threshold voltage is shifted in a negative (−) direction by ΔVth according to a duration of on time, as shown in the graph of FIG. 6. However, in the double gate structure according to the current embodiment of the present invention, a stable threshold voltage may be maintained reducing ΔVth during a duration of on time, as shown in FIG. 7. In addition, an electrical field generated by the top gate 28 may block an electron flow in the channel layer 14, thereby preventing an increase in a photo current generated by the channel layer 14 due to incident light. Thus, light sensitivity of the driving transistor 20 and the switch transistor 22 may be reduced. As will be described below, the driving transistor 20 and the switch transistor 22 are covered by a black matrix in a pixel, and thus the influence of light thereon may be further reduced.

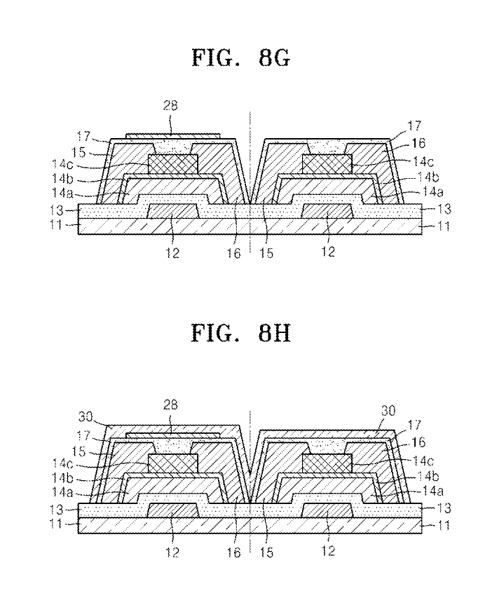

FIGS. 8A through 8H are cross-sectional views illustrating a method of manufacturing a driving transistor 20 and a switch transistor 22 and a light-sensing transistor 10 at the same time, according to an embodiment of the present invention.

First, referring to FIG. 8A, two gates 12 are separately formed on a substrate 11. For example, a gate 12 for a driving transistor 20 and a switch transistor 22 may be formed on the left side, and a gate 12 for a light-sensing transistor 10 may be formed on the right side. The gate 12 may be formed by, for example, completely coating the substrate 11 with a gate material and etching the gate material. As described above, the gate 12 on the left side for the driving transistor 20 and the switch transistor 22 may extend in a direction perpendicular to a surface of the drawing, and the single gate 12 may be shared by a plurality of driving transistors 20 and a plurality of switch transistors 22.

Next, referring to FIG. 8B, a gate insulation film 13 is formed on the substrate 11 and the gate 12 to cover both of the gates 12. Then, first and second channel material layers 31a and 31b, respectively, for forming a channel layer 14 may be sequentially stacked on the gate insulation film 13. For example, the first channel material layer 31a may be formed of InZnO, which is relatively sensitive to light, in order to form a lower channel layer 14a. The second channel material layer 31b formed on the first channel material layer 31a may be formed of GaInZnO to form a central channel layer 14b.

Next, referring to FIG. 8C, a photoresist 32 is formed on each of two regions on the second channel material layer 31b respectively facing the two gates 12, and portions of the first and second channel material layers 31a and 31b where the photoresist 32 is not formed are removed by etching. Then, as illustrated in FIG. 8C, two lower channel layers 14a formed on the gate insulation film 13 and two central channel layers 14b stacked on the two lower channel layers 14a may be formed from the first and second channel material layers 31a and 31b, respectively. As described above, a plurality of driving transistors 20 and a plurality of switch transistors 22 may be arranged in a direction perpendicular to the drawing surface. Accordingly, while only one lower channel layer 14a and only one central channel layer 14b are illustrated on the left side of FIG. 8C, it may be understood that a plurality of lower channel layers 14a and a plurality of central channel layers 14b are arranged in a direction perpendicular to the surface of the drawing. Also, regarding an upper channel layer 14c and a source 15 and a drain 16 which will be described below, it may also be understood that a plurality of them are arranged in a direction perpendicular to the surface of the drawing.

Next, referring to FIG. 8D, a third channel material layer 33 is formed over the gate insulation film 13 and the central channel layer 14b overall, to form an upper channel layer 14c functioning as an etching stop layer. Referring to FIG. 8E, a photoresist 34 is formed on each of two regions on the third channel material layer 33 respectively facing the two central channel layers 14b, and the third channel material layer 33 on a portion where the photoresist 34 is not formed is removing by etching. Consequently, as illustrated in FIG. 8E, the upper channel layers 14c may be respectively formed on the two central channel layers 14b.

Next, referring to FIG. 8F, a source 15 and a drain 16 may be respectively formed on two sides of the two channel layers 14. For example, the source 15 may be formed to extend on portions of a left surface and an upper surface of the channel layer 14 from an upper surface of the gate insulation film 13, and the drain 16 may be formed to extend a right surface and the upper surface of the channel layer 14 from the upper surface of the gate insulation film 13.

Also, referring to FIG. 8G, a passivation layer 17 may be formed to cover at least the source 15, the drain 16, and the upper channel layer 14c. The passivation layer 17 may extend up to the gate insulation film 13. Then, as illustrated in FIG. 8G, to improve the performance of the driving transistor 20 and the switch transistor 22, a top gate 28 is formed on the passivation layer 17 to face the upper channel layer 14c on the passivation layer 17 on one side of the optical touch screen apparatus 100, for example on the left side. The top gate 28 is not formed on the passivation layer 17 on another side, for example on the right side. As described above, the top gate 28 may extend in a direction perpendicular to a ground surface of the drawing; and the single top gate 28 may be shared by a plurality of driving transistors 20 and a plurality of switch transistors 22. In the In-cell type optical touch screen apparatus 100 according to the current embodiment of the present invention, the top gate 28 may be formed together in an operation in which a transparent pixel electrode of the display cell 21 is formed. For example, the top gate 28 may be formed of a transparent conductive material such as ITO or IZO. Although not illustrated in FIG. 8G, a conductive plug 29 that electrically connects the top gate 28 and the gate 12 may be formed before forming the top gate 28, as illustrated in FIG. 4. The conductive plug 29 may be formed at an appropriate location in a pixel of the optical touch screen apparatus 100.

Finally, referring to FIG. 8H, an orientation layer 30 may be formed to cover the passivation layer 17 and the top gate 28. The orientation layer 30 may improve interface characteristics of, for example, a liquid crystal layer formed on the orientation layer 30 and orientation characteristics thereof, and may be formed of, for example, polyimide.

As described above, when applied to the In-cell type optical touch screen apparatus 100, the top gate 28 may be formed together in an operation in which a transparent pixel electrode of the display cell 21 is formed. Accordingly, in the whole manufacturing process of manufacturing the optical touch screen apparatus 100, even when the top gate 28 is further formed on the driving transistor 20 and the switch transistor 22, another operation for forming the top gate 28 is not added. Thus, the addition of the top gate 28 does not influence the overall manufacturing process.

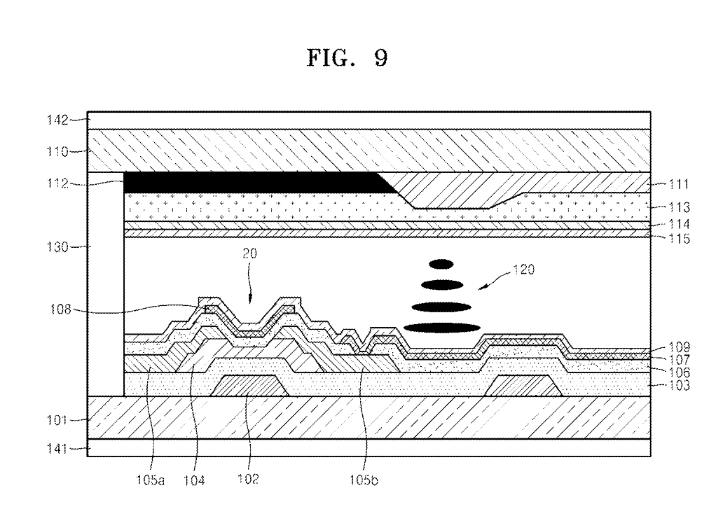

FIG. 9 is a cross-sectional view illustrating a structure of a pixel of the optical touch screen apparatus 100 according to an embodiment of the present invention, for explaining the above-described effects of the embodiments of the present invention. Referring to FIG. 9, the optical touch screen apparatus 100 may include a transparent rear substrate 101 and a transparent front substrate 110 facing each other, a liquid crystal layer 120 filled between the rear substrate 101 and the front substrate 110, and a barrier layer 130 separating two adjacent pixels. Also, a plurality of thin film transistors, electrodes, and other various layers for operating the optical touch screen apparatus 100 may be disposed on an upper surface of the rear substrate 101, and a plurality of color filters, electrodes, and other various layers may be disposed on a lower surface of the front substrate 110. While the plurality of thin film transistors may include the driving transistor 20, the switch transistor 22, and the light-sensing transistor 10, only one driving transistor 20 is schematically illustrated in FIG. 9 for convenience of description and the switch transistor 22 and the light-sensing transistor 10 are omitted. However, the switch transistor 22 and the light-sensing transistor 10 may also be arranged on the rear substrate 101. The liquid crystal layer 120 disposed between the rear substrate 101 and the front substrate 110 functions as the display cell 21 illustrated in FIG. 3.

In detail, a gate 102 is partially formed on the rear substrate 101, and a gate insulation film 103 is coated overall on the gate 102 and the rear substrate 101. A channel layer 104 is partially formed on the gate insulation film 103 facing the gate 102, and a source 105a and a drain 105b are partially formed on two sides of the channel layer 104. While one channel layer 104 is illustrated in FIG. 9 for convenience, the channel layer 104 may also have a multi-layer structure as illustrated in FIG. 4. In addition, a transparent passivation layer 106 is coated to cover the source 105a, the drain 105b, the channel layer 104, and the gate insulation film 103. A first transparent electrode 107 is partially formed on the passivation layer 106 to face the liquid crystal layer 120. The first transparent electrode 107 may be connected to the drain 105b by, for example, passing through the passivation layer 106. Also, a top gate 108 is formed on the passivation layer 106 at a position facing the channel layer 104. Also, an orientation film 109 formed of polyimide may be formed overall on the passivation layer 106, the first transparent electrode 107, and the top gate 108 to improve interface characteristics and orientation characteristics of the liquid crystal layer 120. Also, a first polarization plate 141 may be disposed on a lower surface of the rear substrate 101.

Referring to FIG. 9, the gate 102, the gate insulation film 103, the channel layer 104, the source 105a, the drain 105b, the passivation layer 106, and the top gate 108 may form the driving transistor 20 or the switch transistor 22. The top gate 108 may be formed of the same material as that of the first transparent electrode 107, and may be formed at the same time when the first transparent electrode 107 is formed. That is, the top gate 108 may be formed while the first transparent electrode 107 is being formed. Accordingly, an additional process or an additional mask for forming the top gate 108 is not used. Thus, for the In-cell type optical touch screen apparatus 100, the top gate 108 may be formed without increasing manufacturing costs and manufacturing time.

Also, a color filter 111 for defining colors of emitted light and a black matrix 112 for covering a driving circuit are partially formed on the lower surface of the front substrate 110. The black matrix 112 may be arranged to cover the driving transistor 20, the switch transistor 22, and other circuit devices as illustrated in FIG. 9. Accordingly, a driving circuit including the driving transistor 20 and the switch transistor 22 is not affected by incident light. On the other hand, while not illustrated in FIG. 9, in order that external light may be incident on the light-sensing transistor 10, the black matrix 112 and the color filter 111 may not be formed on portions of the front substrate 110 facing the light-sensing transistor 10. The color filter 111 may be disposed to face the liquid crystal layer 120 which functions as a display cell. Also, the passivation layer 113 is coated overall to cover the black matrix 112 and the color filter 111, and a second transparent electrode 114 is formed on the passivation layer 113. In addition, an orientation film 115 may be coated overall on a surface of the second transparent electrode 114 to improve interface characteristics and orientation characteristics of the liquid crystal layer 120. A second polarization plate 142 may be disposed on an upper surface of the front substrate 110.

It should be understood that the example embodiments described therein should be considered in a descriptive sense only and not for purposes of limitation. Descriptions of features or aspects within each embodiment should typically be considered as available for other similar features or aspects in other embodiments.

What is claimed is:

1. An optical touch screen apparatus comprising:
a display pixel including a display cell and a driving transistor, the display cell configured to display an image and the driving transistor configured to turn on or off the display cell, the driving transistor having a double gate structure; and
a light-sensing pixel including a light-sensing transistor and a switch transistor, the light sensing transistorconfigured to sense incident light and the switch transistor configured to output data from the light-sensing transistor, the switch transistor having the double gate structure,
wherein the double gate structure is a structure in which a bottom gate and a top gate are arranged such that a channel layer is disposed therebetween.

2. The optical touch screen apparatus of claim 1, wherein the light-sensing transistor has a single gate structure that includes a single gate.

3. The optical touch screen apparatus of claim 1, wherein the light-sensing transistor, the driving transistor, and the switch transistor are oxide semiconductor transistors in which a channel layer is formed of an oxide semiconductor.

4. The optical touch screen apparatus of claim 1, wherein the driving transistor and the switch transistor each comprise:
a substrate;
the bottom gate partially disposed on the substrate;
a gate insulation film disposed on the substrate and the bottom gate, the gate insulation film covering the bottom gate;
a source and a drain respectively disposed on two sides of the channel layer to partially cover the two sides of the channel layer, the channel layer disposed on the gate insulation film facing the bottom gate;
a passivation layer disposed to cover the channel layer, the source, and the drain; and
the top gate disposed on the passivation layer to face the channel layer.

5. The optical touch screen apparatus of claim 4, wherein the driving transistor and the switch transistor share a single bottom gate and a single top gate.

6. The optical touch screen apparatus of claim 4, wherein the bottom gate and the top gate are electrically connected to each other such that the bottom gate and the top gate are configured to receive an electrical signal simultaneously.

7. The optical touch screen apparatus of claim 1, wherein the light-sensing transistor comprises:
a substrate;
a gate partially disposed on the substrate;
a gate insulation film disposed on the substrate and the gate to cover the gate;
a channel layer disposed on the gate insulation film to face the gate;
a source and a drain respectively disposed on two sides of the channel layer to cover the two sides of the channel layer; and
a passivation layer disposed to cover the channel layer, the source, and the drain.

8. The optical touch screen apparatus of claim 7, wherein the channel layer of the driving transistor and the switch transistor have the same structure and include the same oxide semiconductor material as those of the channel layer of the light-sensing transistor.

9. The optical touch screen apparatus of claim 1, further comprising:
a gate line configured to supply a gate voltage to the driving transistor and the switch transistor;
an image data line configured to supply an image signal to the display cell;
a light-sensing line configured to output a light-sensing signal from the light-sensing transistor;
a driving voltage line connected to a drain of the light-sensing transistor; and
a reset line configured to supply a reset signal to the light-sensing transistor.

10. The optical touch screen apparatus of claim 9, wherein a source of the driving transistor is connected to the display cell, and the light-sensing transistor and the switch transistor are serially connected to each other.

11. The optical touch screen apparatus of claim 9, wherein the bottom gates and the top gates of the driving transistor and the switch transistor are electrically connected to each other such that the bottom gate and the top gate are configured to receive an electrical signal simultaneously.

12. The optical touch screen apparatus of claim 1, further comprising:
a first transparent substrate and a second transparent substrate, the second transport substrate facing the first transparent substrate;
a first transparent electrode disposed on the first substrate; and
a second transparent electrode disposed below the second substrate.

13. The optical touch screen apparatus of claim 12, wherein the driving transistor, the switch transistor, and the optical transistor are disposed on the first transparent substrate, and the display cell is disposed between the first transparent electrode and the second transparent electrode.

14. The optical touch screen apparatus of claim 13, wherein the driving transistor and the switch transistor each comprise:
a gate insulation film disposed on the first transparent substrate and the bottom gate to cover the bottom gate, the bottom gate being partially disposed on the first transparent substrate;
a source and a drain respectively disposed on two sides of the channel layer to partially cover the two sides of the channel layer, the channel layer disposed on the gate insulation film facing the bottom gate;
a passivation layer disposed to cover the channel layer, the source, and the drain; and
the top gate disposed on the passivation layer to face the channel layer.

15. The optical touch screen apparatus of claim 14, wherein the first transparent electrode is disposed on the passivation layer to face the display cell, and the top gate and the first transparent electrode are formed of the same material at the same time.

16. The optical touch screen apparatus of claim 13, further comprising a color filter and a black matrix disposed on a lower surface of the second transparent substrate.

17. The optical touch screen apparatus of claim 16, wherein the color filter is disposed to face the display cell, and the black matrix is disposed to face the driving transistor and the switch transistor.

18. A method of manufacturing an optical touch screen apparatus, the method comprising:
forming a display cell between a first transparent substrate and a second transparent substrate, the first transparent substrate having a driving transistor, a light-sensing transistor, a switch transistor and a first transparent electrode formed thereon, the driving transistor and the switch transistor each having a double gate structure, wherein
the double gate structure is a structure in which a bottom gate and a top gate are disposed with a channel layer disposed therebetween.

19. The method of claim 18, wherein the light-sensing transistor has a single gate structure including a single gate.

20. The method of claim 18, further comprising:
forming a first gate of the driving transistor and the switch transistor and a second gate of the light-sensing transistor on the first transparent substrate;
forming a gate insulation film on the first transparent substrate and the first and second gates to cover the first and second gates;
forming a first channel layer and a second channel layer on the gate insulation film to respectively face the first gate and the second gate;
forming a first source and a first drain on two sides of the first channel layer to partially cover the two sides of the first channel layer,
forming a second source and a second drain on two sides of the second channel layer to partially cover the two sides of the second channel layer;
forming a passivation layer to cover the first and second channel layers, the first and second sources, and the first and second drains; and
forming a third gate on the passivation layer to face the first channel layer.

21. The method of claim 20, wherein the bottom gate is the first gate, and the top gate is the third gate.

22. The method of claim 20, wherein the driving transistor and the switch transistor share a single first gate and a single third gate.

23. The method of claim 20, further comprising electrically connecting the first gate and the third gate to each other.

24. The method of claim 20, wherein the first channel layer and the second channel layer have the same structure and are made of the same oxide semiconductor material.

25. The method of claim 20, further comprising forming the first transparent electrode on the passivation layer to face the display cell,
wherein the first transparent electrode and the third gate are formed of the same material at the same time.

26. The method of claim 18, wherein the providing the second transparent substrate comprises:
forming a color filter on a lower surface of the second transparent substrate to face the display cell; and
forming a black matrix on the lower surface of the second transparent substrate to face the driving transistor and the switch transistor.
